(19) United States
(12) Patent Application Publication
(10) Pub. No.: US 2026/0099988 A1
(43) Pub. Date: Apr. 9, 2026

(54) MULTI-VIEW THREE-DIMENSIONAL POINT CLOUD RECONSTRUCTION

(71) Applicant: International Business Machines Corporation, Armonk, NY (US)

(72) Inventors: Jing Zhang, Shanghai (CN); Shi Yun Liang, Shanghai (CN); Yuan Yuan Ding, Shanghai (CN); Yu Pan, Shanghai (CN)

(21) Appl. No.: 18/911,091

(22) Filed: Oct. 9, 2024

(51) Int. Cl. G06T 15/10; G06T 15/08; G06V 10/82; G06V 20/00

(52) U.S. Cl. CPC G06T 15/10; G06T 15/08; G06V 10/82; G06V 20/00; G06T 2210/56; G06T 2210/61

(57) ABSTRACT

An example operation includes one or more of executing a neural network on an image of a scene to generate a description of the scene, generating a prompt that includes the description of the scene and a request to generate multiple views of the scene, executing a machine learning model on the prompt to generate multiple descriptions of the multiple views of the scene, respectively, the machine learning model having been trained to perform one or more generative tasks, and executing a transformer model on the multiple descriptions of the multiple views of the scene and the image of the scene to generate a three-dimensional visual representation of the scene in virtual space.

### BACKGROUND

The present invention relates to artificial intelligence, image analysis, generation of three-dimensional images, computer vision, virtual reality, augmented reality, and/or autonomous driving.

### SUMMARY

One example embodiment provides a computer-implemented method that may include one or more of executing a neural network on an image of a scene to generate a description of the scene, generating a prompt that includes the description of the scene and a request to generate multiple views of the scene, executing a machine learning model on the prompt to generate multiple descriptions of the multiple views of the scene, respectively, the machine learning model having been trained to perform one or more generative tasks, and executing a transformer model on the multiple descriptions of the multiple views of the scene and the image of the scene to generate a three-dimensional visual representation of the scene in virtual space.

Another example embodiment provides a computer system that may include a processor set, a set of one or more computer-readable storage media, and program instructions, collectively stored in the set of one or more storage media, that cause the processor set to perform computer operations that may include one or more of execute a neural network on an image of a scene to generate a description of the scene, generate a prompt that includes the description of the scene and a request to generate multiple views of the scene, execute a machine learning model on the prompt to generate multiple descriptions of the multiple views of the scene, respectively, the machine learning model having been trained to perform one or more generative tasks, and execute a transformer model on the multiple descriptions of the multiple views of the scene and the image of the scene to generate a three-dimensional visual representation of the scene in virtual space.

A further example embodiment provides a computer program product that may include a set of one or more computer-readable storage media, and program instructions, collectively stored in the set of one or more computer-readable storage media, for causing a processor set to perform computer operations that may include one of more of executing a neural network on an image of a scene to generate a description of the scene, generating a prompt that includes the description of the scene and a request to generate multiple views of the scene, executing a machine learning model on the prompt to generate multiple descriptions of the multiple views of the scene, respectively, the machine learning model having been trained to perform one or more generative tasks, and executing a transformer model on the multiple descriptions of the multiple views of the scene and the image of the scene to generate a three-dimensional visual representation of the scene in virtual space.

### BRIEF DESCRIPTION OF THE DRAWINGS

FIG. 1 is a diagram illustrating a computing environment according to an embodiment of the instant solution.

FIG. 2A is a diagram illustrating a computing environment for 3D point cloud generation according to the examples and features of the instant solution.

FIG. 2B is a diagram illustrating a process of generating a 3D point cloud representation from raw image data according to the examples and features of the instant solution.

FIG. 3A is a diagram illustrating a process of generating a semantic description of a scene according to the examples and features of the instant solution.

FIG. 3B is a diagram illustrating a process of generating a prompt according to the examples and features of the instant solution.

FIG. 3C is a diagram illustrating a process of generating a description of multiple different views of a scene according to the examples and features of the instant solution.

FIG. 3D is a diagram illustrating a process of embedding image content and text content of a scene into a combined embedding according to the examples and features of the instant solution.

FIG. 3E is a diagram illustrating a process of generating a 3D point cloud reconstruction of a scene based on the combined embedding according to the examples of features of the instant solution.

FIG. 3F is a diagram illustrating an example of a 3D point cloud reconstruction of a scene according to the examples of features of the instant solution.

FIG. 4A illustrates a flow diagram, according to example embodiments.

FIG. 4B illustrates a flow diagram, according to example embodiments.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

According to an aspect of the example embodiments, there is provided a computer-implemented method that includes executing a neural network on an image of a scene to generate a description of the scene, generating a prompt that includes the description of the scene and a request to generate multiple views of the scene, executing a machine learning model on the prompt to generate multiple descriptions of the multiple views of the scene, respectively, the machine learning model having been trained to perform one or more generative tasks, and executing a transformer model on the multiple descriptions of the multiple views of the scene and the image of the scene to generate a three-dimensional visual representation of the scene in virtual space. A technical advantage of the apparatus is that a more accurate a three-dimensional point cloud representation of an image can be generated in comparison to traditional point cloud generation systems because semantic information about a scene is considered along with the image data thereby enabling a better visual understanding of the scene.

In some embodiments, the neural network may include an image captioning model, and the executing the neural network may include executing the image captioning model on the image of the scene to generate a semantic description of spatial relationships between objects in the scene. The technical effect of this feature is generating a semantic description from an image for use in generating a 3D point cloud representation of the image.

In some embodiments, the neural network may include a contrastive learning model, and the executing the neural network may include connecting the image of the scene to text an embedding space and generating the description of the scene based on the text. The technical effect of this feature is using a machine learning model to identify text that is similar to images based on a shared embedding space for the text and the images.

In some embodiments, generating the prompt may include inserting the description of the scene into a prompt template to generate the prompt, where the prompt template may include a request to generate descriptions of different views of the scene from different perspectives. The technical advantage of this feature is using prompt engineering to instruct a large language model to generate rich semantic information about a scene that can be used for enhancing 3D point cloud reconstruction of the scene.

In some embodiments, the executing the machine learning model on the prompt may include executing the machine learning model on the prompt to generate descriptions of some or all of a group consisting of a view from a top of the scene, a view from a bottom of the scene, a view from left of the scene, and a view from right of the scene. The technical effect of this feature is creating different descriptions of different views of the same scene which provide rich semantic information to be used during 3D point cloud reconstruction of the scene.

In some embodiments, executing the transformer model may include executing a two-dimensional view encoder on the multiple descriptions of the multiple views of the scene and the image of the scene to generate encodings. The technical effect of this feature is converting both image data and semantic text data into the same format (vector encodings) such that both the image data and the text data can be fused together.

In some embodiments, executing the transformer model may further include executing a three-dimensional volume decoder on the encodings to generate the three-dimensional visual representation of the scene in virtual space. The technical benefit of this feature is that both the image data and the semantic data are fused together and used to generate the three-dimensional representation of the scene, rather than just image data. The result is a more accurate three-dimensional representation of the scene.

According to an aspect of the example embodiments, there is provided a computer system that includes a processor set, a set of one or more computer-readable storage media, and program instructions, collectively stored in the set of one or more storage media, for causing the processor set to perform operations that include executing a neural network on an image of a scene to generate a description of the scene, generating a prompt that includes the description of the scene and a request to generate multiple views of the scene, executing a machine learning model on the prompt to generate multiple descriptions of the multiple views of the scene, respectively, the machine learning model having been trained to perform one or more generative tasks, and executing a transformer model on the multiple descriptions of the multiple views of the scene and the image of the scene to generate a three-dimensional visual representation of the scene in virtual space. A technical advantage of the computer-implemented method is that a more accurate a three-dimensional point cloud representation of an image can be generated in comparison to traditional point cloud generation systems because semantic information about a scene is considered along with the image data thereby enabling a better visual understanding of the scene.

In some embodiments for the computer operations caused to be performed by the processor set executing the program instructions of the computer system, the neural network may include an image captioning model, and the executing the neural network may include executing the image captioning model on the image of the scene to generate a semantic description of spatial relationships between objects in the scene. The technical effect of this feature is generating a semantic description from an image for use in generating a 3D point cloud representation of the image.

In some embodiments for the computer operations caused to be performed by the processor set executing the program instructions of the computer system, the neural network may include a contrastive learning model, and the executing the neural network may include connecting the image of the scene to text an embedding space and generating the description of the scene based on the text. The technical effect of this feature is using a machine learning model to identify text that is similar to images based on a shared embedding space for the text and the images.

In some embodiments for the computer operations caused to be performed by the processor set executing the program instructions of the computer system, generating the prompt may include inserting the description of the scene into a prompt template to generate the prompt, where the prompt template may include a request to generate descriptions of different views of the scene from different perspectives. The technical advantage of this feature is using prompt engineering to instruct a large language model to generate rich semantic information about a scene that can be used for enhancing 3D point cloud reconstruction of the scene.

In some embodiments for the computer operations caused to be performed by the processor set executing the program instructions of the computer system, the executing the machine learning model on the prompt may include executing the machine learning model on the prompt to generate descriptions of some or all of a group consisting of a view from a top of the scene, a view from a bottom of the scene, a view from left of the scene, and a view from right of the scene. The technical effect of this feature is creating different descriptions of different views of the same scene which provide rich semantic information to be used during 3D point cloud reconstruction of the scene.

In some embodiments for the computer operations caused to be performed by the processor set executing the program instructions of the computer system, executing the transformer model may include executing a two-dimensional view encoder on the multiple descriptions of the multiple views of the scene and the image of the scene to generate encodings. The technical effect of this feature is converting both image data and semantic text data into the same format (vector encodings) such that both the image data and the text data can be fused together.

In some embodiments for the computer operations caused to be performed by the processor set executing the program instructions of the computer system, executing the transformer model may further include executing a three-dimensional volume decoder on the encodings to generate the three-dimensional visual representation of the scene in virtual space. The technical benefit of this feature is that both the image data and the semantic data are fused together and used to generate the three-dimensional representation of the scene, rather than just image data. The result is a more accurate three-dimensional representation of the scene.

According to an aspect of the example embodiments, there is provided a computer program product that includes a set of one or more computer-readable storage media, and program instructions, collectively stored in the set of one or more computer-readable storage media, for causing a processor set to perform computer operations that include executing a neural network on an image of a scene to generate a description of the scene, generating a prompt that includes the description of the scene and a request to generate multiple views of the scene, executing a machine learning model on the prompt to generate multiple descriptions of the multiple views of the scene, respectively, the machine learning model having been trained to perform one or more generative tasks, and executing a transformer model on the multiple descriptions of the multiple views of the scene and the image of the scene to generate a three-dimensional visual representation of the scene in virtual space. A technical advantage of the computer program product is that a more accurate a three-dimensional point cloud representation of an image can be generated in comparison to traditional point cloud generation systems because semantic information about a scene is considered along with the image data thereby enabling a better visual understanding of the scene.

In some embodiments for the computer operations caused to be performed by the processor set executing the program instructions of the computer program product, the neural network may include an image captioning model, and the executing the neural network may include executing the image captioning model on the image of the scene to generate a semantic description of spatial relationships between objects in the scene. The technical effect of this feature is generating a semantic description from an image for use in generating a 3D point cloud representation of the image.

In some embodiments for the computer operations caused to be performed by the processor set executing the program instructions of the computer program product, the neural network may include a contrastive learning model, and the executing the neural network may include connecting the image of the scene to text an embedding space and generating the description of the scene based on the text. The technical effect of this feature is using a machine learning model to identify text that is similar to images based on a shared embedding space for the text and the images.

In some embodiments for the computer operations caused to be performed by the processor set executing the program instructions of the computer program product, generating the prompt may include inserting the description of the scene into a prompt template to generate the prompt, where the prompt template may include a request to generate descriptions of different views of the scene from different perspectives. The technical advantage of this feature is using prompt engineering to instruct a large language model to generate rich semantic information about a scene that can be used for enhancing 3D point cloud reconstruction of the scene.

In some embodiments for the computer operations caused to be performed by the processor set executing the program instructions of the computer program product, the executing the machine learning model on the prompt may include executing the machine learning model on the prompt to generate descriptions of some or all of a group consisting of a view from a top of the scene, a view from a bottom of the scene, a view from left of the scene, and a view from right of the scene. The technical effect of this feature is creating different descriptions of different views of the same scene which provide rich semantic information to be used during 3D point cloud reconstruction of the scene.

In some embodiments for the computer operations caused to be performed by the processor set executing the program instructions of the computer program product, executing the transformer model may include executing a two-dimensional view encoder on the multiple descriptions of the multiple views of the scene and the image of the scene to generate encodings. The technical effect of this feature is converting both image data and semantic text data into the same format (vector encodings) such that both the image data and the text data can be fused together.

In some embodiments for the computer operations caused to be performed by the processor set executing the program instructions of the computer program product, executing the transformer model may further include executing a three-dimensional volume decoder on the encodings to generate the three-dimensional visual representation of the scene in virtual space. The technical benefit of this feature is that both the image data and the semantic data are fused together and used to generate the three-dimensional representation of the scene, rather than just image data. The result is a more accurate three-dimensional representation of the scene.

The system described herein may be hosted within a software application, a service, or the like, which may be hosted by a host platform such as a cloud platform, a web server, a database, or the like.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community with shared concerns (e.g., mission, security requirements, policy, and compliance considerations). It may be managed by organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

The example embodiments are directed to an innovative system for generating 3D representations of an image, also referred to as 3D point cloud reconstruction. The system leverages multiple artificial intelligence/machine learning models (e.g., an ensemble, etc.) including a large language model that is configured to extract semantic features (textual descriptions, etc.) from the raw image data and integrate it into existing 3D reconstruction neural networks. For example, the image data may be processed using a pre-trained large language model that can obtain semantic representations of the images, which include higher-level semantic information such as object categories, scene descriptions, and contextual relationships.

The semantic features can be integrated into feature extraction and representation stages of a 3D reconstruction neural network. According to various embodiments, by combining geometric information from a scene with semantic information from the scene, the system can achieve a more comprehensive and accurate 3D point cloud reconstruction. This is because the combination of text and images can better capture the details and semantic correlations present in the images. The system fuses together both the image data and the semantic text data using a combination of embedding models and neural networks. The use of large language models from the natural language processing domain with the task of 3D reconstruction provides new insights and methods for the image-to-3D point cloud reconstruction process.

The direct use of a single image for 3D reconstruction often leads to unsatisfactory results due to the limited amount of information available from the image. However, even a single image typically contains rich textual content that can vividly describe the color, detailed features, and spatial relationships between objects. Additionally, leveraging the information from existing images and combining it with a current generative language model allows for the expansion of associations with the image content from different perspectives, enriching the scene information. The example embodiments describe a system that can extract this semantic data from the image and use to during a 3D reconstruction process which incorporates the semantic data.

Some of the benefits of the example embodiments including combining large language models in the field of natural language processing with 3D reconstruction tasks to generate more accurate 3D point cloud reconstructions (in virtual space) of raw image data than compared to traditional 3D construction processes which do not rely on semantic information. This is because, in comparison to traditional 3D reconstruction systems, the introduction of a large language model which can extract richer semantic features from images, can significantly improve the accuracy of reconstruction and the ability to restore details.

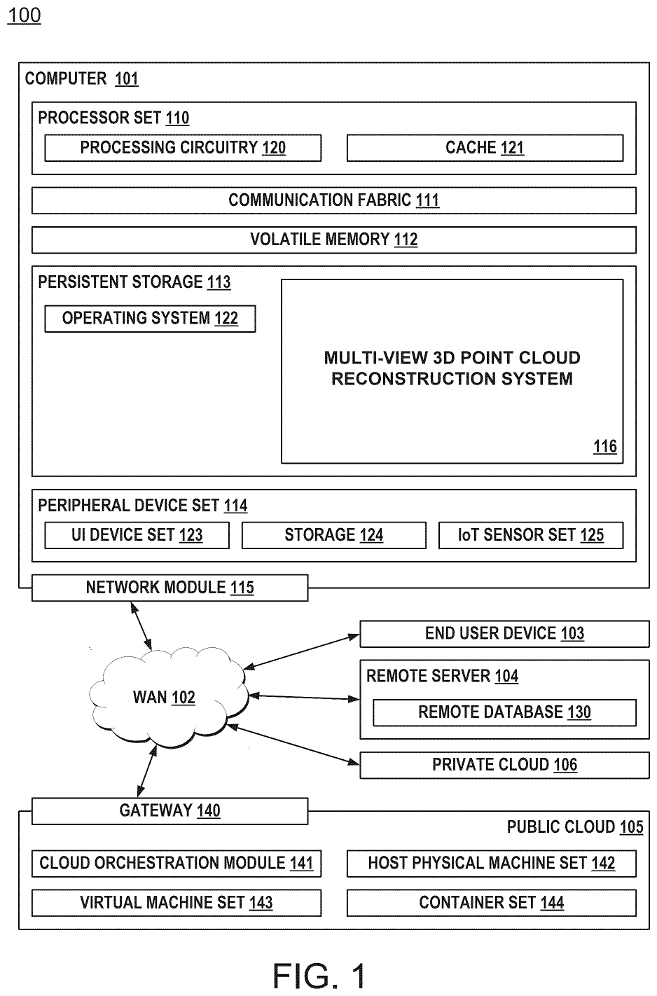

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as multi-view 3D point cloud reconstruction system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

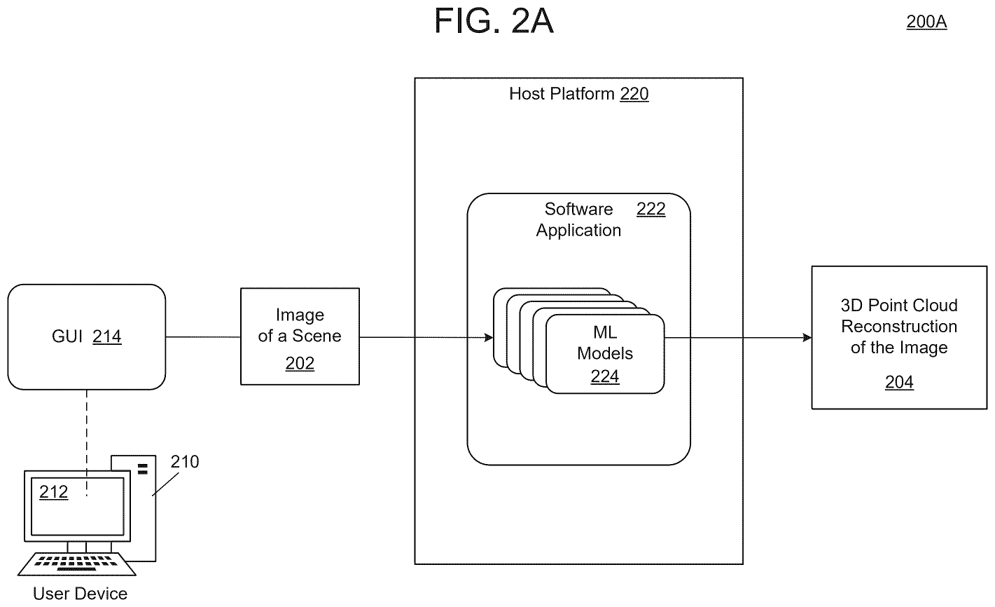

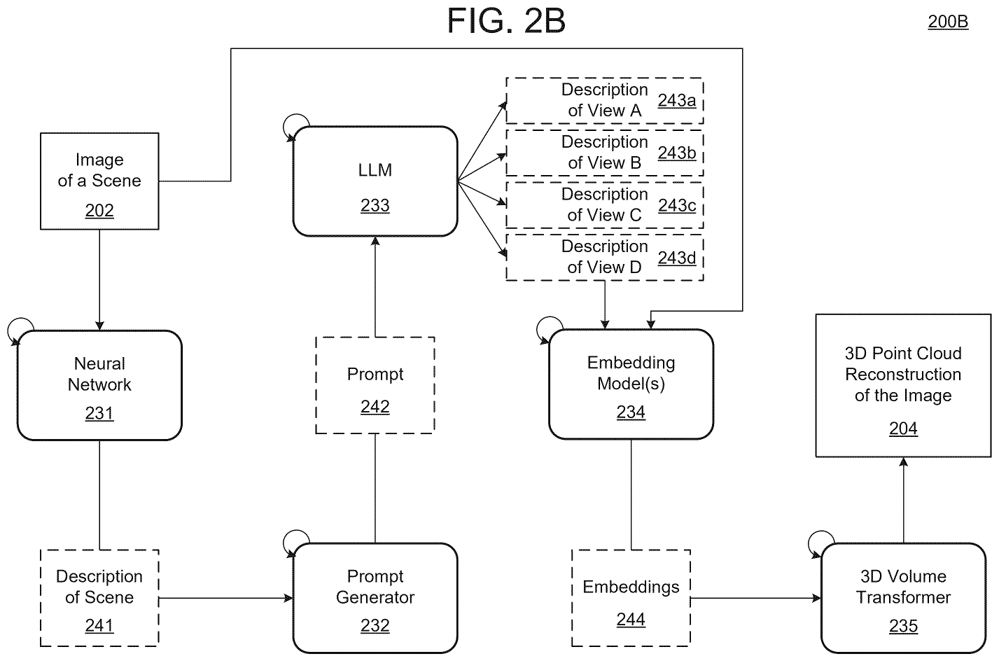

FIG. 2A illustrates a computing environment 200A for 3D point cloud generation according to the examples and features of the instant solution. Referring to FIG. 2A, a host platform 220 may host a software application 222 which may be used for generating a 3D point cloud “reconstruction” of an image of a scene 202. This generation is based on at least one machine learning (ML) model 224, e.g., by using at least one ML model 224. In the examples herein, the at least one ML model 224 may include a sequence of models. A script may be used to transfer an output from one model of the sequence of models to an input of another model of the sequence of models in an automated manner.

The host platform 220 may be a cloud platform, a web server, a database, a combination of systems, and the like. The host platform 220 may provide the software application 222 via an IP address on the World Wide Web. For example, the software application 222 may be a web application resource (WAR) application. As another example, the software application 222 may include a back-end hosted on the host platform 220 and a front-end that is installed within a user device. In the example of FIG. 2A, a user may use a user device 210 to connect to the host platform 220 over a computer network such as the Internet, a private network, or the like.

In some embodiments, a user may use the user device 210 to view a graphical user interface (GUI) 214 of the software application 222 on a display device 212 of the user device 210. In this example, the user may upload the image of the scene 202, for example, a .JPEG file, a .PNG file, a .TIFF file, a .BMP file, or the like. The image may include raw image data such as an image captured using a camera, or the like. Here, the user may input commands on the GUI 214 to upload the image of the scene 202. As another example, the user may input commands on the GUI 214 to trigger a conversion of the image of the scene 202 into a 3D point cloud reconstruction of the image 204. For example, the user may press a button and browse to add an image file such as the image of the scene 202 using the GUI 214. The button press may cause the software application 222 to execute the at least one ML model 224 to convert the image of the scene 202 into the 3D point cloud reconstruction of the image 204.

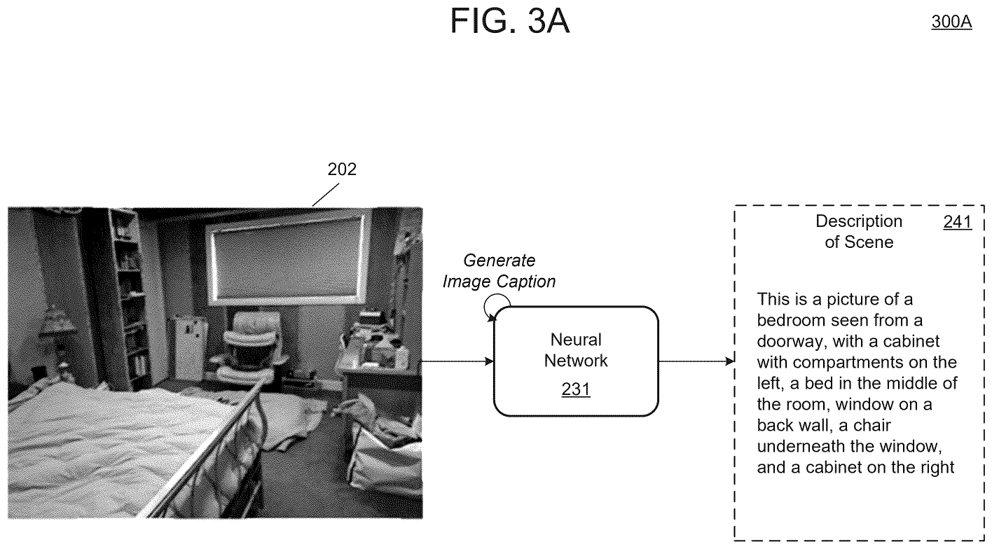

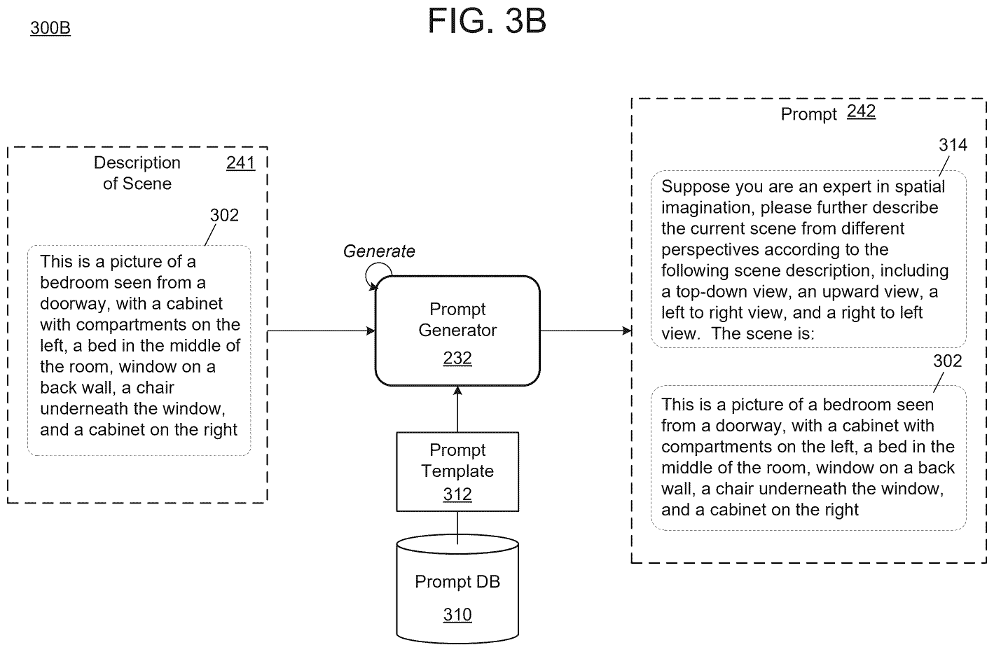

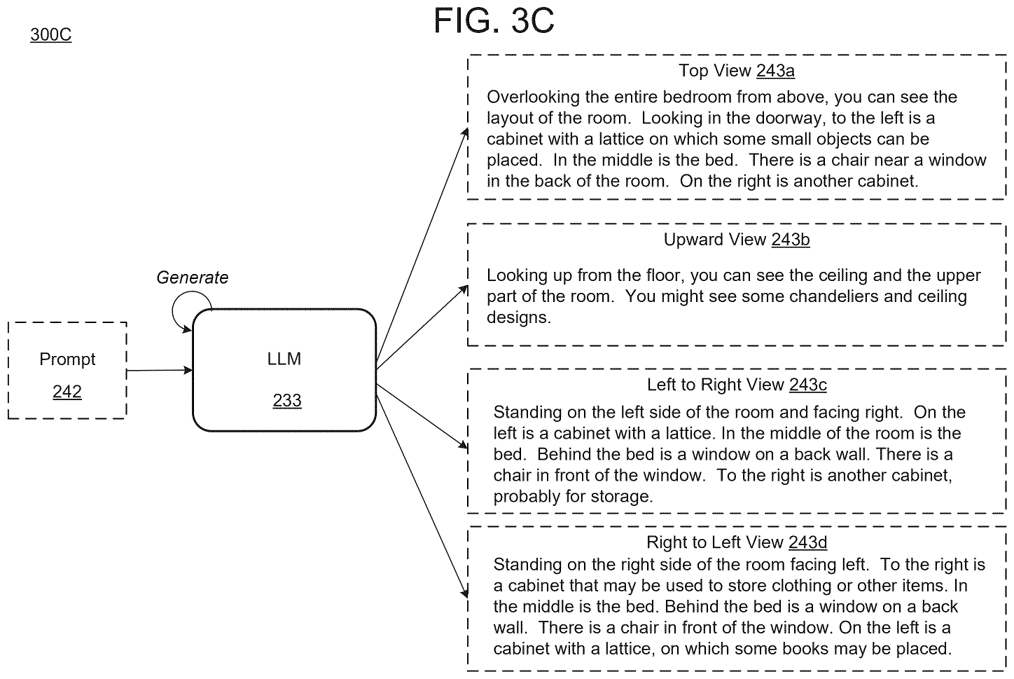

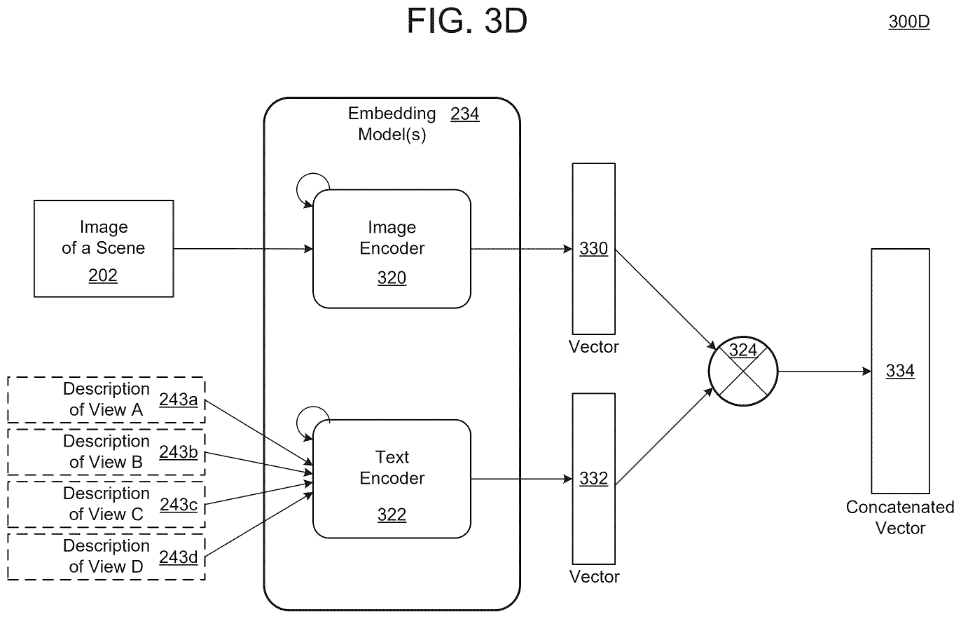

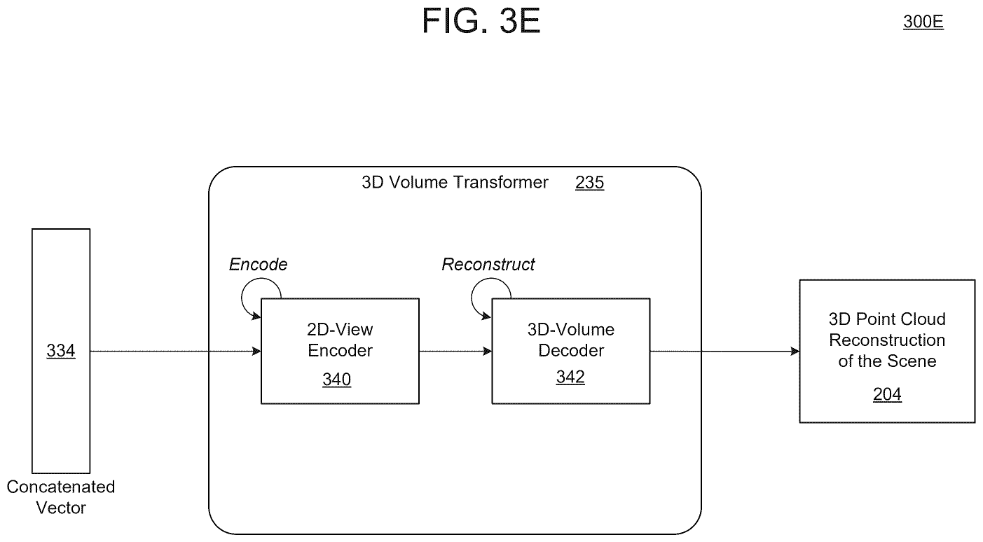

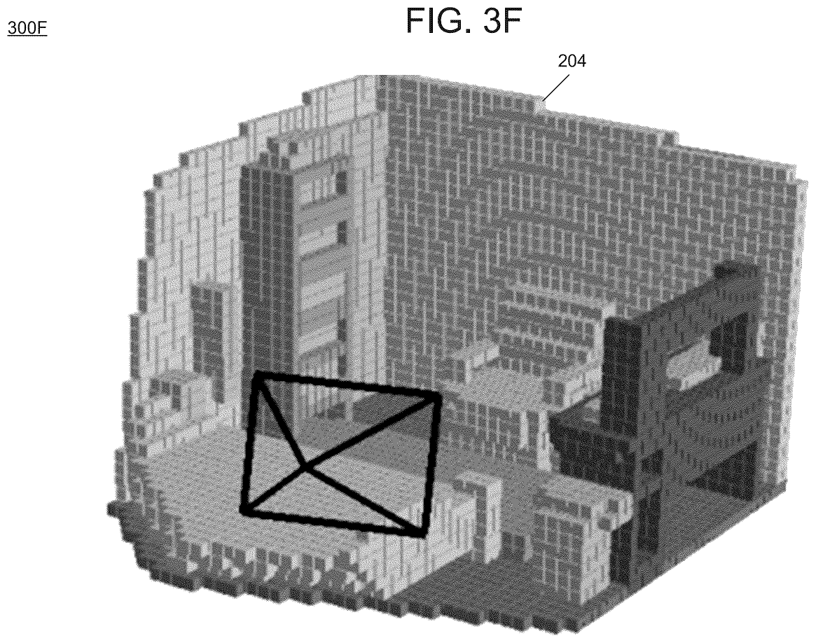

FIG. 2B illustrates a process 200B of generating a 3D point cloud representation from raw image data according to the examples and features of the instant solution. For example, the process 200B may be performed by the software application 222 shown in FIG. 2A using the at least one ML model 224. In this example, the at least one ML model 224 includes a sequence of ML models including a neural network 231, a LLM 233, at least one embedding model 234, and a 3D volume transformer model 235. Additional examples of the neural network 231, the LLM 233, the at least one embedding model 234, and the 3D volume transformer model 235 are further described herein with respect to FIGS. 3A-3E.

Referring now to FIG. 2B, in this example, the image of the scene 202 is input to a neural network 231 which is configured to generate a description of the scene 241. The description of the scene 241 may include a textual description of the content within the raw image data of the image of the scene 202. In some embodiments, the neural network 231 is referred to herein as an “image captioning” model because it can create a description of the scene 241 in response to receiving, as input, the image of the scene 202.

For example, in some embodiments the neural network 231 has been trained to identify connections between text and images. For example, the neural network 231 may be a BLIP-2 model which stands for “Bootstrapping Language-Image Pre-training with Frozen Image Encoders and Large Language Models”. The BLIP-2 system leverages frozen pre-trained image encoders and LLMs by training a lightweight multi-layer (e.g., twelve layer) transformer encoder in multi-stage training. In a first training stage, vision-language representation learning is bootstrapped from a frozen image encoder. In a second training stage, vision-to-language generative learning is bootstrapped from a frozen language model. The BLIP-2 model achieves state of the art performance on various vision-language tasks. As another example, the neural network 231 may be a Clip model which is a contrastive language model (deep learning model) that combines both images and text into an embedding space enabling the model to identify text and images that are similar (similar embedding locations).

Both Clip and BLIP-2 are vision-language models that work on bridging the gap between visual and textual information. BLIP-2 combines vision and language understanding to generate descriptive text from images and can be used for tasks such as image captioning, visual question answering, and other vision-language tasks. CLIP is a vision-language model that learns to connect images and text in a shared embedding space. CLIP is trained using a contrastive learning approach where it learns to match images with corresponding textual descriptions and distinguish them from unrelated pairs. CLIP can be used for various tasks including zero-shot image classification, where it can classify images based on textual descriptions without additional training. It excels at understanding and generating text descriptions that are semantically aligned with visual content.

A prompt generator 232 may receive the output (e.g., the description of the scene 241) from the neural network 231 and generate a prompt 242 which includes a combination of the description of the scene 241 and a request to generate descriptions of different views of the scene 241 based on the description of the scene 241. Here, the prompt generator 232 may use a template (fixed text) in combination with the description of the scene 241 which is dynamically generated by the neural network 231 to generate the prompt 242. The template is saved in memory to be used for various inputs and, in some embodiments, the prompt generator 232 accesses the stored template to use the stored template with a new output from the neural network 231 (e.g., a new description of a scene) to generate the prompt 242. Thus, the prompt generator 232 in at least some embodiments is a software component that executes automatically in response to receiving the description of the scene 241. A user is able to upload a pre-selected template that is to be used by the prompt generator 232.

The prompt 242 may be input to the LLM 233 which is configured to generate descriptions of different views of the scene 243a, 243b, 243c, and 243d. Here, the LLM 233 may generate the descriptions as if looking at the scene from different perspectives including a top-down perspective, a bottom-up perspective (upward), a left-to-right perspective, a right-to-left perspective, and/or the like. As a result, the description of the scene 241 may be converted into the descriptions of different views of the scene 243a, 243b, 243c, and 243d, based on the LLM 233 executing on the prompt 242. The large language model (LLM) may be a pre-trained machine learning model that has been trained to perform natural language understanding and generation, and it may be used to generate diverse textual descriptions from different perspectives.

In this example, the descriptions of different views of the scene 243a, 243b, 243c, and 243d, and the image of the scene 202 may be input to the at least one embedding model 234 and converted into embeddings 244 in an embedding space (e.g., vector space). That is, both the descriptions and the image data may each be converted into a common embedding space that is shared by both text and images. In some embodiments, the at least one embedding model 234 may include a combination of models/encoders with a first encoder configured to convert the image data to the embedding space and a second encoder configured to convert the descriptions into the embedding space.

In this example, the embeddings 244 may be input to the 3D volume transformer model 235 which converts the embeddings 244 into the 3D point cloud reconstruction of the image 204. An example of the 3D volume transformer model 235 may include a 2D-view encoder and a 3D-volume decoder. The 2D-view encoder encodes the relevant information amongst different views via view attention layers. The 3D-volume decoder learns global correlations of different spatial locations in volume attention layers and predicts the final 3D volume output. The system may split the 3D space into a set of tokens and the predicted volumes for each token are finally stitched into the final 3D reconstruction output.

The 2D-view encoder in the 3D volume transformer model 235 is responsible for processing and integrating features derived from both image and text embeddings. This integration helps capture a comprehensive representation of the scene from multiple views and perspectives, which is crucial for accurate 3D reconstruction. The 3D volume transformer model 235 uses self-attention mechanisms within a transformer-based architecture to process concatenated embeddings. This approach allows the model to capture complex dependencies between the visual and textual data. The input consists of concatenated embeddings from the image encoder and the text encoder. The output is a refined multi-view virtual representation of the scene. Here, the final embeddings are used after passing through a series of self-attention layers and normalization steps.

FIG. 3A illustrates a process 300A of generating a semantic description of a scene according to the examples and features of the instant solution. Referring to FIG. 3A, the image of the scene 202 is input to the neural network 231. In response, the neural network 231 generates the description of the scene 241. In this example, the description of the scene 241 is a textual description of the overall scene including a textual description of all of the items in the scene, a textual description of spatial relationships of the items with respect to each other, a textual description of colors, a textual description of locations, and the like. As mentioned previously, the description of the scene 241 may be generated using a CLIP model, a BLIP-2 model, or the like.

According to various embodiments, the description of the scene 241 may be output by the neural network 231, and input to the prompt generator 232, for example, via a script that is executed by the software application 222 shown in FIG. 2A.

FIG. 3B illustrates a process 300B of generating a prompt 242 according to the examples and features of the instant solution. Referring to FIG. 3B, the prompt generator 232 may receive, as input, the description of the scene 241 generated by the neural network 231. In this example, the prompt generator 232 may query a prompt database 310 for a prompt template 312. The prompt template 312 may include an empty slot and a fixed description 314 (static text content) which is the same each time the prompt generator 232 generates a request for a scene regardless of the image content. Here, the prompt generator 232 may combine the prompt template 312 (including the fixed description 314) with text content 302 from the description of the scene 241 to generate the prompt 242. In some embodiments, the entire text content from the description of the scene 241 may be used to fill in the empty slot in the prompt template 312.

FIG. 3C illustrates a process 300C of generating the description of different views of a scene 243a, 243b, 243c, and 243d, according to the examples and features of the instant solution. Referring to FIG. 3C, the prompt 242 generated in FIG. 3B may be input to the LLM 233 via a script that is running through the software application 222 shown in the example of FIG. 2A. That is, the prompt 242 may be output by the prompt generator 232 and input to the LLM 233 in an automated manner via an executable script. Here, the LLM 233 may generate four different descriptions of four different view/perspectives of the same/common scene based on the instructions in the prompt 242 which includes the fixed description 314 and the text content 302 shown in FIG. 3B.

In this example, the four descriptions that are generated correspond to four different views of the same scene including a top-down view of the scene, a bottom-up view of the scene, a left-to-right view of the scene, and a right-to-left view of the scene. Each of the four descriptions may include overlapping content therein including objects, positions of the objects, locations of other items in the scene such as walls, windows, etc. and the like. In some embodiments, the descriptions may include colors, shading, patterns, and/or the like.

FIG. 3D illustrates a process 300D of embedding image content and text content of a scene into a combined embedding according to the examples and features of the instant solution. Referring to FIG. 3D, the at least one embedding model 234 may include a combination of encoders including an image encoder 320 and a text encoder 322. Here, the image encoder 320 may receive the image of the scene 202 and convert the image of the scene 202 into a vector 330 within a shared embedding space/vector space. Meanwhile, the text encoder 322 may receive the descriptions of the different views of the scene 243a, 243b, 243c, and 243d, and convert them into a vector 332 within the shared embedding space/vector space. A concatenator 324 may receive the vector 330 and the vector 332 and concatenate the vectors together to generate a concatenated vector 334 (final embedding). The concatenation process may include placing the vectors 330 and 332 side-by-side to create the concatenated vector 334. Software libraries integrated within the software application may be used to perform the concatenation process.

FIG. 3E illustrates a process 300E of generating a 3D point cloud reconstruction of the image 204 based on the combined embedding according to the examples of features of the instant solution. Referring to FIG. 3E, the concatenated vector 334 output from the at least one embedding model 234 in FIG. 3D, may be input to the 3D volume transformer model 235. Here, in the depicted embodiment the 3D volume transformer model 235 includes a 2D-view encoder 340 and a 3D-view decoder 342.

Here, the 2D-view encoder 340 may be responsible for processing and integrating features derived from both image and text embeddings. This integration helps capture a comprehensive representation of the scene from multiple views and perspectives. It uses self-attention mechanisms within a transformer-based architecture to process the concatenated embeddings. This approach allows the model to capture complex dependencies between the visual and textual data. The input consists of concatenated embeddings from the image encoder and the text encoder. The 3D-volume decoder learns global correlations of different spatial locations in volume attention layers and predicts the final 3D volume output.

The resulting output may include the 3D point cloud reconstruction of the image 204 which may include a virtual representation of the scene and it may be displayed on the GUI 214 that is shown in the example of FIG. 2A. Here, the 3D point cloud reconstruction of the image 204 may include a virtual image in virtual space made up of many different points in virtual space. The 3D point cloud reconstruction 204 may be a virtual reality (VR) image, an augmented reality (AR) image, or the like, which is generated by the host software application. An example of the 3D point cloud reconstruction 204 is shown in a view 300F in FIG. 3F. Here, the points combine to make a virtual image of the scene in virtual space. Thus, the original image of the scene (picture) is converted into a virtual image of the scene. This display is in some embodiments part of one or more of a virtual reality experience for a user, an augmented reality for a user, an automated driving experience for a user, etc.

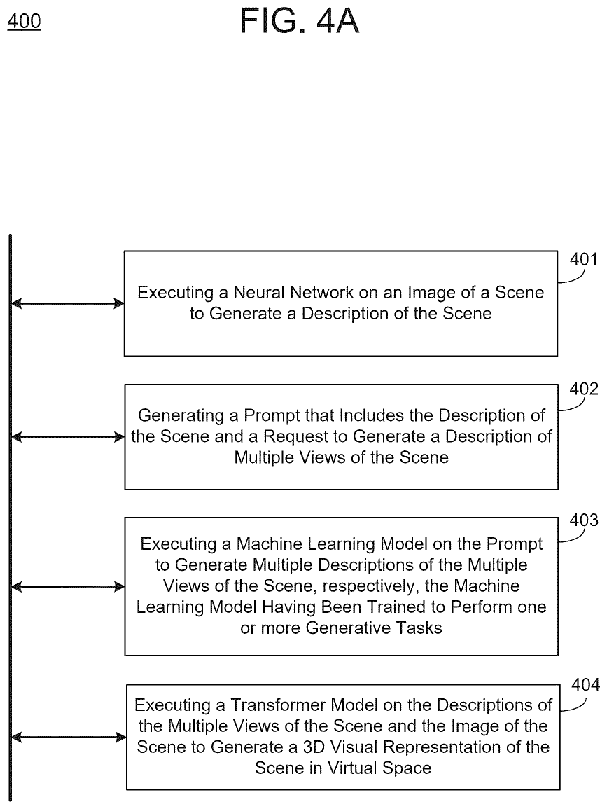

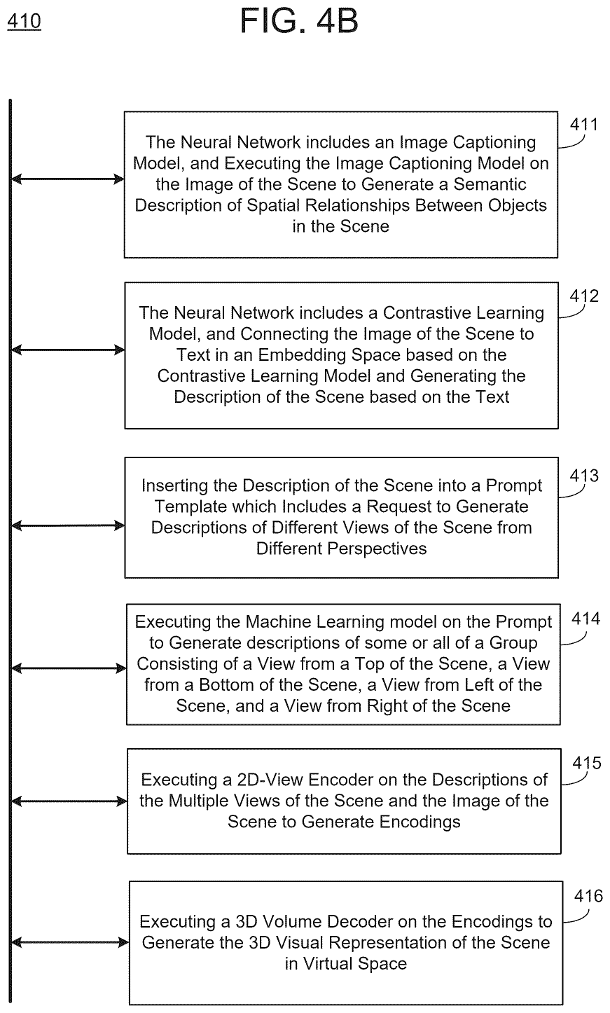

FIG. 4A illustrates a flow diagram of a method 400, according to example embodiments. Referring to FIG. 4A, the method 400 may include executing a neural network on an image of a scene to generate a description of the scene in 401. The method may include generating a prompt that includes the description of the scene and a request to generate multiple views of the scene in 402. The method may include executing a large language model (LLM) on the prompt to generate multiple descriptions of the multiple views of the scene, respectively in 403. The method may include executing a transformer model on the multiple descriptions of the multiple views of the scene and the image of the scene to generate a three-dimensional visual representation of the scene in virtual space in 404.

FIG. 4B illustrates a flow diagram of a method 410, according to example embodiments. Referring to FIG. 4B, in 411, the neural network may include an image captioning model, and the executing the neural network may include executing the image captioning model on the image of the scene to generate a semantic description of spatial relationships between objects in the scene. In 412, the neural network may include a contrastive learning model, and the executing the neural network may include connecting the image of the scene to text in an embedding space based on the contrastive learning model and generating the description of the scene based on the text.

In 413, the generating the prompt may include inserting the description of the scene into a prompt template to generate the prompt, where the prompt template comprises a request to generate descriptions of different views of the scene from different perspectives. In 414, the executing the LLM on the prompt may include executing the LLM on the prompt to generate descriptions of a view from a top of the scene, a view from a bottom of the scene, a view from left of the scene, and a view from right of the scene. In 415, the executing the transformer model may include executing a two-dimensional view encoder on the multiple descriptions of the multiple views of the scene and the image of the scene to generate encodings. In 416, the executing the transformer model may further include executing a three-dimensional volume decoder on the encodings to generate the three-dimensional visual representation of the scene in virtual space.

Detailed descriptions of training a machine learning model and executing a machine learning model are further described and depicted herein.

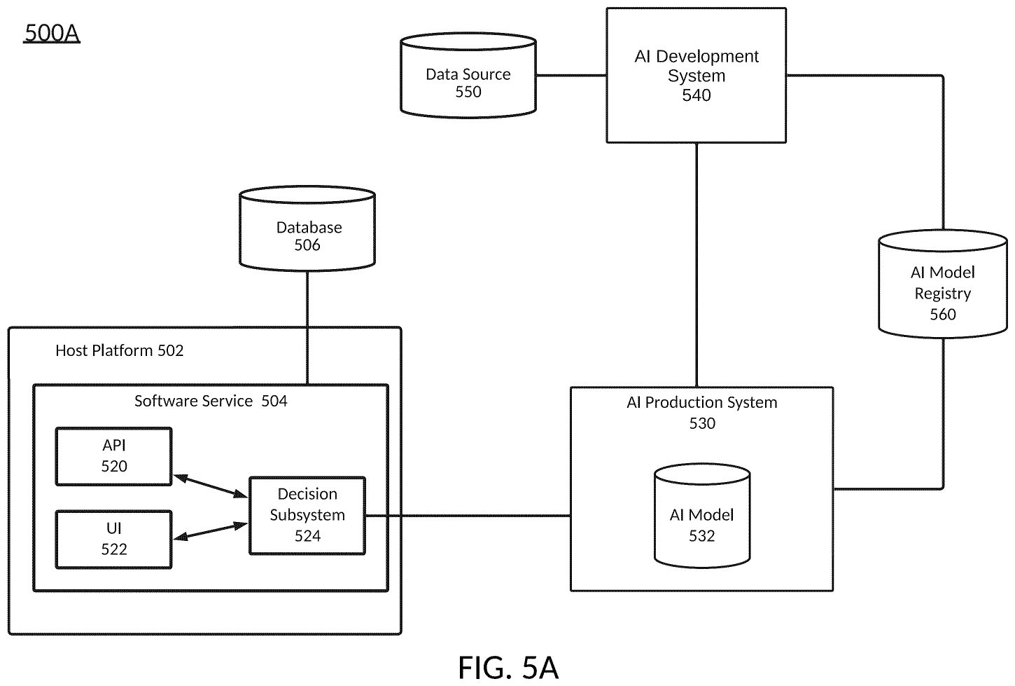

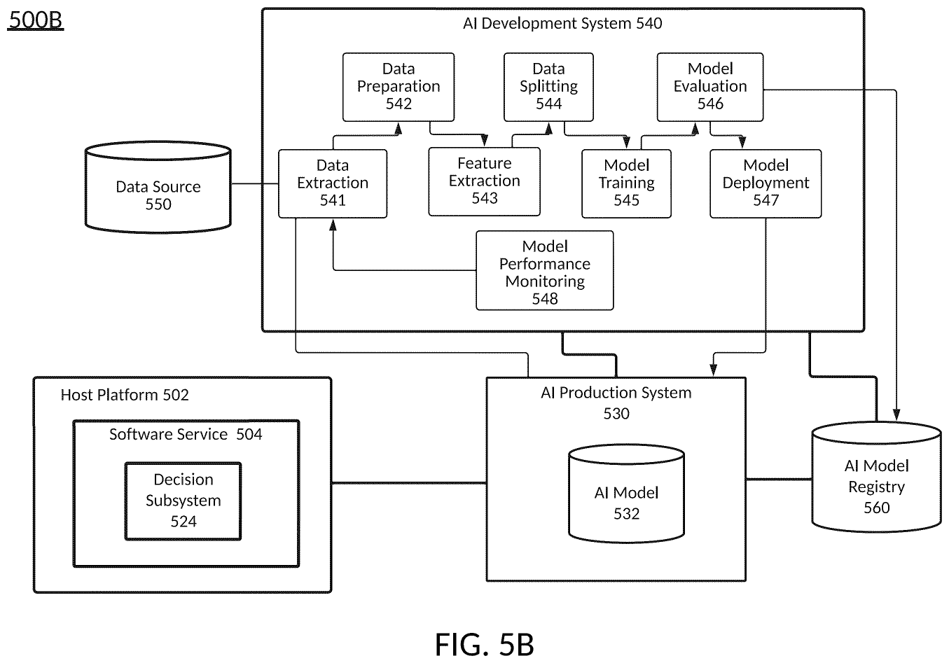

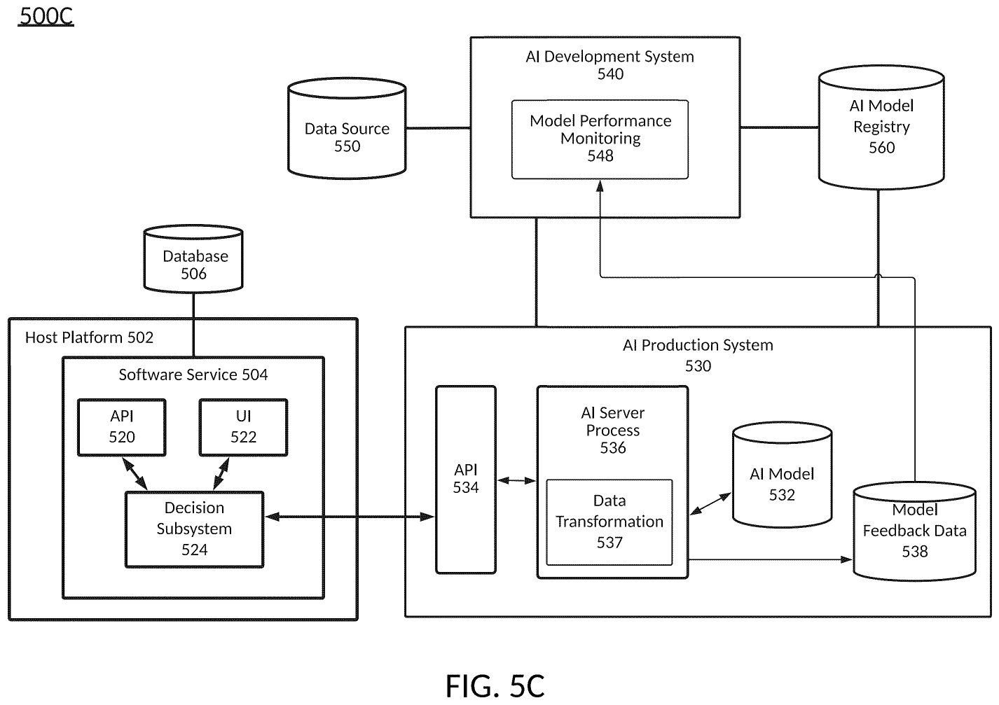

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a neural network, an LLM, an embedding model, a 3D volume transformer, and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content—such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or create entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a massive corpora of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they've acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants (like IBM watsonx Assistant and Google's BARD) to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method comprising:
executing a neural network on an image of a scene to generate a description of the scene;
generating a prompt that includes the description of the scene and a request to generate multiple views of the scene;
executing a machine learning model on the prompt to generate multiple descriptions of the multiple views of the scene, respectively, the machine learning model having been trained to perform one or more generative tasks; and
executing a transformer model on the multiple descriptions of the multiple views of the scene and the image of the scene to generate a three-dimensional visual representation of the scene in virtual space.

2. The computer-implemented method of claim 1, wherein the neural network comprises an image captioning model, and the executing the neural network comprises executing the image captioning model on the image of the scene to generate a semantic description of spatial relationships between objects in the scene.

3. The computer-implemented method of claim 1, wherein the neural network comprises a contrastive learning model, and the executing the neural network comprises connecting the image of the scene to text in an embedding space based on the contrastive learning model and generating the description of the scene based on the text.

4. The computer-implemented method of claim 1, wherein the generating the prompt comprises inserting the description of the scene into a prompt template to generate the prompt, where the prompt template comprises a request to generate descriptions of different views of the scene from different perspectives.

5. The computer-implemented method of claim 1, wherein the executing the machine learning model on the prompt comprises executing the machine learning model on the prompt to generate descriptions of some or all of a group consisting of a view from a top of the scene, a view from a bottom of the scene, a view from left of the scene, and a view from right of the scene.

6. The computer-implemented method of claim 1, wherein the executing the transformer model comprises executing a two-dimensional view encoder on the multiple descriptions of the multiple views of the scene and the image of the scene to generate encodings.

7. The computer-implemented method of claim 6, wherein the executing the transformer model further comprises executing a three-dimensional volume decoder on the encodings to generate the three-dimensional visual representation of the scene in virtual space.

8. A computer system comprising:
a processor set;
a set of one or more computer-readable storage media; and
program instructions, collectively stored in the set of one or more storage media, that cause the processor set to perform computer operations comprising:
execute a neural network on an image of a scene to generate a description of the scene;
generate a prompt that includes the description of the scene and a request to generate multiple views of the scene;
execute a machine learning model on the prompt to generate multiple descriptions of the multiple views of the scene, respectively, the machine learning model having been trained to perform one or more generative tasks; and
execute a transformer model on the multiple descriptions of the multiple views of the scene and the image of the scene to generate a three-dimensional visual representation of the scene in virtual space.

9. The computer system of claim 8, wherein the neural network comprises an image captioning model, and the execution of the neural network comprises execute the image captioning model on the image of the scene to generate a semantic description of spatial relationships between objects in the scene.

10. The computer system of claim 8, wherein the neural network comprises a contrastive learning model, and the execution of the neural network comprises connection of the image of the scene to text in an embedding space based on the contrastive learning model and generate the description of the scene based on the text.

11. The computer system of claim 8, wherein the generation of the prompt comprises insert the description of the scene into a prompt template to generate the prompt, where the prompt template comprises a request to generate descriptions of different views of the scene from different perspectives.

12. The computer system of claim 8, wherein the execution of the machine learning model on the prompt comprises executing the machine learning model on the prompt to generate descriptions of some or all of a group consisting of a view from a top of the scene, a view from a bottom of the scene, a view from left of the scene, and a view from right of the scene.

13. The computer system of claim 8, wherein the execution of the transformer model comprises execute a two-dimensional view encoder on the multiple descriptions of the multiple views of the scene and the image of the scene to generate encodings.

14. The computer system of claim 13, wherein the execution of the transformer model further comprises execute a three-dimensional volume decoder on the encodings to generate the three-dimensional visual representation of the scene in virtual space.

15. A computer program product comprising:
a set of one or more computer-readable storage media; and
program instructions, collectively stored in the set of one or more computer-readable storage media, for causing a processor set to perform computer operations comprising:
executing a neural network on an image of a scene to generate a description of the scene;
generating a prompt that includes the description of the scene and a request to generate multiple views of the scene;
executing a machine learning model on the prompt to generate multiple descriptions of the multiple views of the scene, respectively, the machine learning model having been trained to perform one or more generative tasks; and
executing a transformer model on the multiple descriptions of the multiple views of the scene and the image of the scene to generate a three-dimensional visual representation of the scene in virtual space.

16. The computer program product of claim 15, wherein the neural network comprises an image captioning model, and the executing the neural network comprises executing the image captioning model on the image of the scene to generate a semantic description of spatial relationships between objects in the scene.

17. The computer program product of claim 15, wherein the neural network comprises a contrastive learning model, and the executing the neural network comprises connecting the image of the scene to text in an embedding space based on the contrastive learning model and generating the description of the scene based on the text.

18. The computer program product of claim 15, wherein the generating the prompt comprises inserting the description of the scene into a prompt template to generate the prompt, where the prompt template comprises a request to generate descriptions of different views of the scene from different perspectives.

19. The computer program product of claim 15, wherein the executing the machine learning model on the prompt comprises executing the machine learning model on the prompt to generate descriptions of some or all of a group consisting of a view from a top of the scene, a view from a bottom of the scene, a view from left of the scene, and a view from right of the scene.

20. The computer program product of claim 15, wherein the executing the transformer model comprises executing a two-dimensional view encoder on the multiple descriptions of the multiple views of the scene and the image of the scene to generate encodings, and executing a three-dimensional volume decoder on the encodings to generate the three-dimensional visual representation of the scene in virtual space.
